(19) United States
(12) Patent Application Publication
(10) Pub. No.: US 2005/0086516 A1
(43) Pub. Date: Apr. 21, 2005

(54) Data processing apparatus

(75) Inventors: Naofumi Ueda, Souraku-gun (JP); Katsuyoshi Fujiwara, Sennan-gun (JP); Yuji Okamoto, Souraku-gun (JP); Syouichirou Yoshiura, Ikoma-gun (JP)

Correspondence Address: EDWARDS & ANGELL, LLP, P.O. BOX 55874, BOSTON, MA, 02205, US

(73) Assignee: Sharp Kabushiki Kaisha

(21) Appl. No.: 10/970,094

(22) Filed: Oct. 20, 2004

(30) Foreign Application Priority Data
Oct. 21, 2003 (JP) 2003-360966

(51) Int. Cl. H04L 9/00

(52) U.S. Cl. 713/200

(57) ABSTRACT

A data processing apparatus receives data by, for example, reading an image with an image reading unit, stores the received data in a temporary storage unit, judges whether or not the received data is data satisfying a condition including predetermined characteristics, such as paper money or securities, by a judgment unit, and erases the data after processing it if the data does not satisfy the predetermined condition. If the data satisfies the predetermined condition, the data processing apparatus restricts the processing of the data, and retains the data in an archive unit without erasing it.

This non-provisional application claims priority under 35 U.S.C. §119(a) on Patent Application No. 2003-360966 filed in Japan on Oct. 21, 2003, the entire contents of which are hereby incorporated by reference.

### BACKGROUND OF THE INVENTION

The present invention relates to a data processing apparatus capable of leaving evidence when an attempt to illegally process data such as paper money or securities was made.

Nowadays, copying machines are installed in many and unspecified places in town, such as convenience stores, stationery shops or supermarkets, so that a great number of ordinary users can easily make copies by bringing documents to these shops. Recent copying machines employ advanced digital techniques, and multi function type copying machines have been put into practice. The multi function type copying machines have a plurality of functions, such as the facsimile function for transmitting image data to other apparatus through a communication network and the printer function for receiving image data from an external apparatus and recording the image, in addition to the copying function for capturing an image as image data by scanning the image recorded on a document, and forming and recording an image on recording paper based on the captured image data. Thus, in addition to a copying service, a facsimile service and further a printing service to output data received through communication networks, such as the Internet, or data brought by users, are realized using the copying machines in town. Moreover, development of color copying machines as well as digital copying machines has being carried out, and copying machines capable of making color copies are installed in town.

In order to process digital image data, a digital copying machine comprises storing means, such as a hard disk or a semiconductor memory, for temporarily storing image data read by processing an image. According to an instruction inputted by a user, the image data stored in the storing means is processed, for example, outputted or transmitted by facsimile communication.

When the next user causes the copying machine to read the next document, the storing means stores new image data, so that image data stored in the storing means of the copying machine is overwritten with the new image data and invalidated. Further, there is a copying machine in which the contents stored in the storing means are erased when the power of the copying machine is turned off, or when the copying machine which has been turned off is activated. However, in copying machines installed in shops which are open 24 hours, or copying machines which are not turned off, the past image data is stored in the storing means until it is overwritten with new image data.

Documents from which copies are made by users by using copying machines in town may include confidential information, such as a document in which personal information is written. The state in which image data including confidential information is stored in the storing means of a copying machine over a long time is not preferable in terms of information security. Therefore, as shown by an image processing apparatus disclosed in Japanese Patent Application Laid-Open No. 9-284572 (1997), techniques of erasing the image data stored in the storing means when the processing of the image data such as outputting of the image has been finished were developed.

By the way, since a digital copying machine can produce precise copies by making color copies, it has the function of restricting copying of specific images, such as paper money or securities. When an attempt to copy a specific image such a paper money or securities was made, the copying machine performs a function, that is, judges from the characteristics of the read image that the image is a specific image, and stops the copying process. In the case where the copying machine has the function of erasing image data stored in the storing means, even when an attempt to copy a specific image such as paper money or securities was made, the read image data is erased from the storing means. Therefore, there is a problem that, even when an illegal operation to copy a specific image such as paper money or securities was performed, the copying machine does not have an ability to retain the evidence of the illegal operation.

### BRIEF SUMMARY OF THE INVENTION

The present invention has been made with the aim of solving the above problem, and it is an object of the present invention to provide a data processing apparatus having an ability to retain the evidence of illegal operations by providing a data processing apparatus, including means for erasing stored data when processing has been finished, with means for retaining the data without erasing it if the received data satisfies a predetermined condition.

A data processing apparatus according to the present invention is a data processing apparatus comprising data receiving means for receiving data; storing means (storage unit) for storing the data received by the data receiving means; processing means for processing the data stored in the storing means (storage unit); and invalidating means for invalidating the data stored in the storing means (storage unit), and characterized by comprising: judging means for judging whether or not the data received by the data receiving means satisfies a predetermined condition; and prohibiting means for prohibiting the invalidating means from invalidating the data if the judging means judges that the data satisfies the predetermined condition.

In the present invention, the data processing apparatus for performing processing on data received by capturing an image, for example, such as recording of data as an image on a record carrier, comprises means for storing the received data and invalidating the stored data after completing the processing of the data, and further judges whether or not the received data is data satisfying a predetermined condition, such as data about copying paper money, and prohibits the invalidation of data if the data satisfies the predetermined condition.

A data processing apparatus according to the present invention is characterized by further comprising means (second storage unit) for storing information relevant to data which was judged to satisfy the predetermined condition by the judging means.

In the present invention, for the data satisfying the predetermined condition such as paper money or securities, information relevant to the data, such as the received date of the data or the content of processing, is stored.

A data processing apparatus according to the present invention is characterized in that the storing means (storage unit) includes a temporary storage unit for temporarily storing the data received by the data receiving means, and an archive unit for retaining data which is prohibited from being invalidated by the prohibiting means.

In the present invention, the data processing apparatus comprises the temporary storage unit for temporarily storing the received data, and the archive unit for retaining data which is prohibited from being invalidated.

A data processing apparatus according to the present invention is characterized by further comprising means for giving notification that the prohibiting means has prohibited the invalidation of the data.

In the present invention, the notification that the invalidation of the data has been prohibited is given.

A data processing apparatus according to the present invention is characterized by further comprising: operation receiving means for receiving an operation of a user; identifying means for identifying output authority to output data which was judged to satisfy the predetermined condition by the judging means, if the operation receiving means receives a specific operation; and outputting means for outputting of the data when the identifying means identified the output authority.

In the present invention, when a predetermined operation was received, the output authority to output the data which was judged to satisfy the predetermined condition is identified, and the output of the data which was judged to satisfy the predetermined condition is allowed when the output authority was identified.

A data processing apparatus according to the present invention is characterized by further comprising: displaying means for displaying data as an image; and recording means for recording data as an image on a record carrier, wherein the outputting means outputs the data stored in the storing means (storage unit) to the displaying means or the recording means.

In the present invention, the data which was judged to satisfy the predetermined condition is outputted by displaying it on the displaying means, or recording it as an image on a record carrier.

A data processing apparatus according to the present invention is characterized in that the identifying means identifies a plurality of types of output authority, and the outputting means specifies an output method for the data, according to the type of output authority identified by the identifying means.

In the present invention, a plurality of types of output authority are identified, and an output method is specified according to the type of the identified output authority.

A data processing apparatus according to the present invention is characterized in that the outputting means restricts reproducibility of the data when outputting the data, according to the type of output authority identified by the identifying means.

In the present invention, the reproducibility when outputting data which was judged to satisfy the predetermined condition is restricted according to the type of the identified output authority.

A data processing apparatus according to the present invention is characterized in that the outputting means outputs information relevant to data which was judged to be data satisfying the predetermined condition by the judging means in association with the data.

In the present invention, information relevant to data which was judged to satisfy the predetermined condition is outputted together with the data.

A data processing apparatus according to the present invention is characterized by further comprising means for restricting the processing of the data performed by the processing means, if the judging means judges that the data received by the data receiving means is predetermined specific data.

Further, in the present invention, for the data which was judged to satisfy the predetermined condition, the content of processing performed by the data processing apparatus is restricted.

In the present invention, if data satisfying a predetermined condition such as paper money or securities is received by the data processing apparatus that processes received data while storing the data and invalidates the data by, for example, erasing it after completing the processing of the data, the data processing apparatus prohibits the invalidation of the received data and retains the data. Therefore, when an illegal operation such as copying of paper money was performed, it is possible to retain the evidence of the illegal operation.

Moreover, in the present invention, by storing the information relevant to the data, such as the received date of the data or the content of processing, it is possible to retain more detailed evidence of the illegal operation.

Additionally, in the present invention, since the archive unit for retaining data which is prohibited from being invalidated is provided separately from the temporary storage unit for storing the received data for processing purposes, a normal storage area for processing data is not influenced by the retained data, and the processing ability of the data processing apparatus is maintained.

Further, in the present invention, by giving the notification that the invalidation of the received data has been inhabited, the user can take appropriate actions, for example, the shop staff in a shop where the data processing apparatus is installed can report the fact to the management agency of the data processing apparatus.

Besides, in the present invention, the data processing apparatus receives a predetermined operation, identifies the output authority to output data which was judged to satisfy the predetermined condition, and enables the output of the data when the output authority was identified. Therefore, a specified user such as the shop staff in the shop can confirm the contents of the data stored in the archive unit.

Moreover, in the present invention, since data can be outputted by displaying the data on the displaying means or recording the data as an image, it is possible to select an output method for the data, according to a purpose such as just confirming the data by eyes, or retaining the data by recoding it on paper.

Further, in the present invention, the data processing apparatus can identify a plurality of types of output authority, and an output method is specified according to the type of the identified output authority, thereby enabling an operation according to the responsibility of a user.

Additionally, in the present invention, by restricting the reproducibility such as size or colors when outputting data, according to the type of output authority, it is possible to prevent data from being retrieved and used illegally with output authority that can be used by many users.

Moreover, in the present invention, since information relevant to data which was judged to satisfy the predetermined condition can also be outputted in association with the data, it is possible to confirm more detailed information about the data.

Further, in the present invention, for the data which was judged to satisfy the predetermined condition, by restricting the processing performed by the data processing apparatus, such as prohibiting output, reducing the number of colors, or decreasing the resolution, the present invention provides advantageous effects including preventing illegal use of data, such as preventing copying of paper money.

The above and further objects and features of the invention will more fully be apparent from the following detailed description with accompanying drawings.

### BRIEF DESCRIPTION OF THE SEVERAL VIEWS OF THE DRAWINGS

FIG. 1 is a functional block diagram showing the internal functional structure of a data processing apparatus of the present invention;

FIG. 2 is a flowchart showing the steps of processing performed by the data processing apparatus; and

FIG. 3 is a flowchart showing the processing steps performed by the data processing apparatus to output the data stored in an archive unit.

### DETAILED DESCRIPTION OF THE INVENTION

The following description will specifically explain the present invention, based on the drawings illustrating an embodiment thereof.

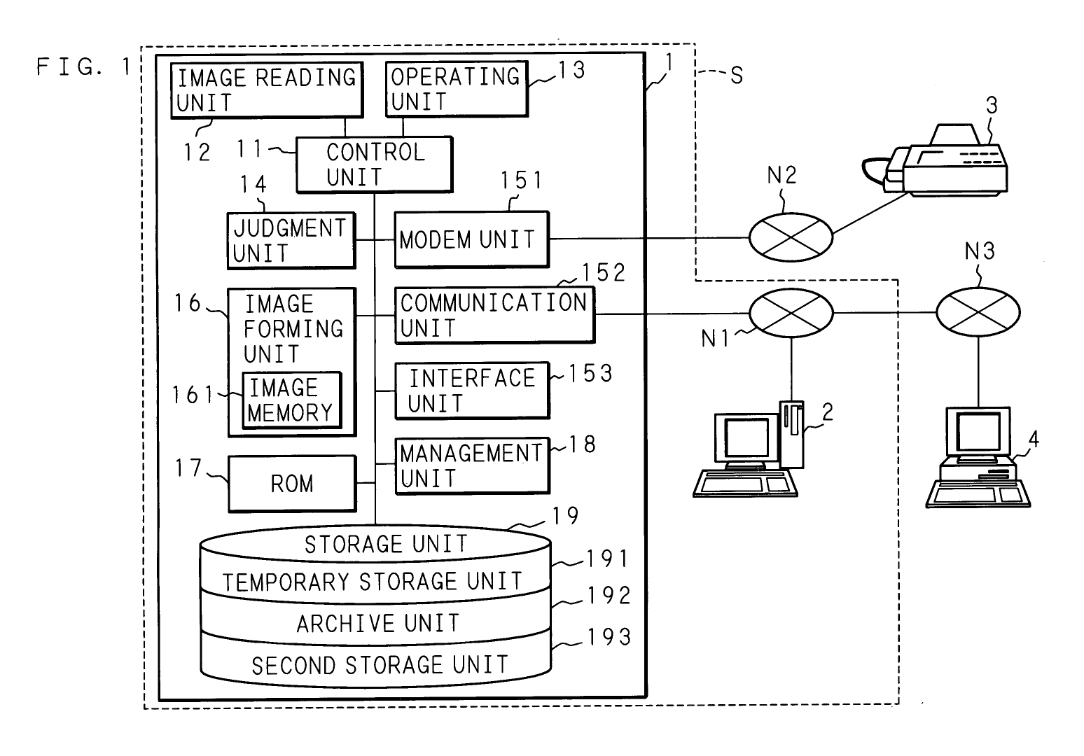

FIG. 1 is a functional block diagram showing the internal functional structure of a data processing apparatus of the present invention. The data processing apparatus 1 is a copying machine and installed in a shop S, such as a convenience store, a stationery shop or a supermarket, in town. The data processing apparatus 1 comprises a control unit 11, including a CPU for performing arithmetic operations and a RAM for storing temporary information relating to arithmetic operations. A ROM 17 storing a control program for controlling the data processing apparatus 1 is connected to the control unit 11, and the control unit 11 entirely controls the data processing apparatus 1 according to the control program stored in the ROM 17. Moreover, a management unit 18 that is a memory storing management information for managing the processing performed by the data processing apparatus 1 is connected to the control unit 11, and the control unit 11 refers to the management information stored in the management unit 18 and controls the data processing apparatus 1 based on the referred information.

Further connected to the control unit 11 are an image reading unit 12 that reads an image on a document by scanning and generates electronic image data, and an image forming unit 16. The image forming unit 16 includes therein an image memory 161 for temporarily storing image data, forms an image from the image data, records the formed image on recording paper, and outputs it. The data processing apparatus 1 generates image data by reading a document in the image reading unit 12, stores the generated image data in the image memory 161, forms an image from the stored image data in the image forming unit 16, and outputs the image, thereby functioning as a copying machine for making copies of the document. In addition, a storage unit (storing means) 19 composed of a hard disk or a non-volatile memory is connected to the control unit 11. The storage unit 19 stores the data processed by the data processing apparatus 1. An operating unit 13 for receiving operations from a user is connected to the control unit 11, and the operating unit 13 comprises displaying means such as a liquid crystal panel for displaying information necessary for operations, and input means such as a touch panel or ten-key which is operated by the user to input information such as control instructions.

Further, a communication unit 152 connected to a communication network N1 in the shop S is connected to the control unit 11. An information processing apparatus 2 such as a POS terminal in the shop S is connected to the communication network N1, so that the communication unit 152 can exchange information with the information processing apparatus 2 over the communication network N1. Moreover, the communication network N1 is connected to an external wide-area communication network N3 such as the Internet. The communication unit 152 can receive, through the communication network N1 and wide-area communication network N3, data transmitted from an information processing apparatus 4, such as a server apparatus or a personal computer (PC), connected to the wide-area communication network N3. The data processing apparatus 1 can receive data from an information processing apparatus 4 specified by the user, and outputs the data as an image from the image forming unit 16.

Besides, a modem unit 151 for performing facsimile communication is connected to the control unit 11 and a public network N2. The data processing apparatus 1 can transmit image data generated by reading a document with the image reading unit 12 to other facsimile machine 3 connected to the public network N2 by facsimile communication through the public network N2 connected to the modem unit 151. Moreover, the data processing apparatus 1 can receive image data transmitted by facsimile communication from the facsimile machine 3 by the modem unit 151 through the public network N2, and then the image forming unit 16 can form an image from the image data received by the modem unit 151 and output it. Thus, the data processing apparatus 1 as a copying machine has the function of a facsimile machine.

Further, an interface unit 153 to which other devices are connectable is connected to the control unit 11. When a user's device such as a PC or a memory card is connected, the data processing apparatus 1 can read data through the interface unit 153 and perform processing such as outputting the data as an image, or transmitting the data by facsimile communication. Besides, the data processing apparatus 1 can output the received data to an external device through the interface unit 153. The image reading unit 12, modem unit 151, communication unit 152, and interface unit 153 function as data receiving means according to the present invention.

Further connected to the control unit 11 is a judgment unit (judging means) 14 for judging whether or not the received data is data satisfying a condition including predetermined characteristics such as paper money or securities. Copying of paper money is prohibited, and it is also necessary to restrict copying of securities. The judgment unit 14 reads a part of or whole data, such as image data generated by reading a document with the image reading unit 12, image data received by the modem unit 151 by facsimile communication, data received by the communication unit 152, and data read by the interface unit 153; extracts the characteristics of the read data; and compares them with the characteristics of predetermined data such as paper money or securities stored therein, thereby judging whether or not the received data is data satisfying a condition including the predetermined characteristics such as paper money or securities.

The storage unit 19 is storing means according to the present invention, and comprises a temporary storage unit 191 for temporarily storing data received by, for example, reading a document image for processing purposes, and an archive unit 192 for retaining the data. The temporary storage unit 191 stores data such as image data generated by reading the document image with the image reading unit 12. The control unit 11 performs processing, such as outputting of the data as an image, for the data stored in the temporary storage unit 191. After the data processing has been finished, the control unit 11 follows the control program stored in the ROM 17, and invalidates the processed data by erasing the data stored in the temporary storage unit 191 or overwriting the data with other data. Thus, the control unit 11 functions as invalidating means according to the present invention.

If the judgment unit 14 judges that the received data is data satisfying the predetermined condition such as paper money or securities, the control unit 11 retains the data in the archive unit 192 without invalidating the data. Thus, the control unit 11 functions as prohibiting means according to the present invention. The archive unit 192 retains data which was judged to be specific data, and also retains information relevant to the data, such as the received date of the data or the instructed number of copies to be outputted, in a second storage unit 193.

The control program stored in the ROM 17 includes an output program for outputting data retained in the archive unit 192, and an identification program for identifying the output authority which instructs the output of the data. The control unit 11 operates as the identifying means of the present invention by following the identification program, and identifies the output authority according to receipt of a specific operation, such as the operation of the user operating the keys of the input means of the operating unit 13 in a specific order. According to the operation of the user from which the output authority was identified, the control unit 11 follows the output program and outputs the data retained in the archive unit 192.

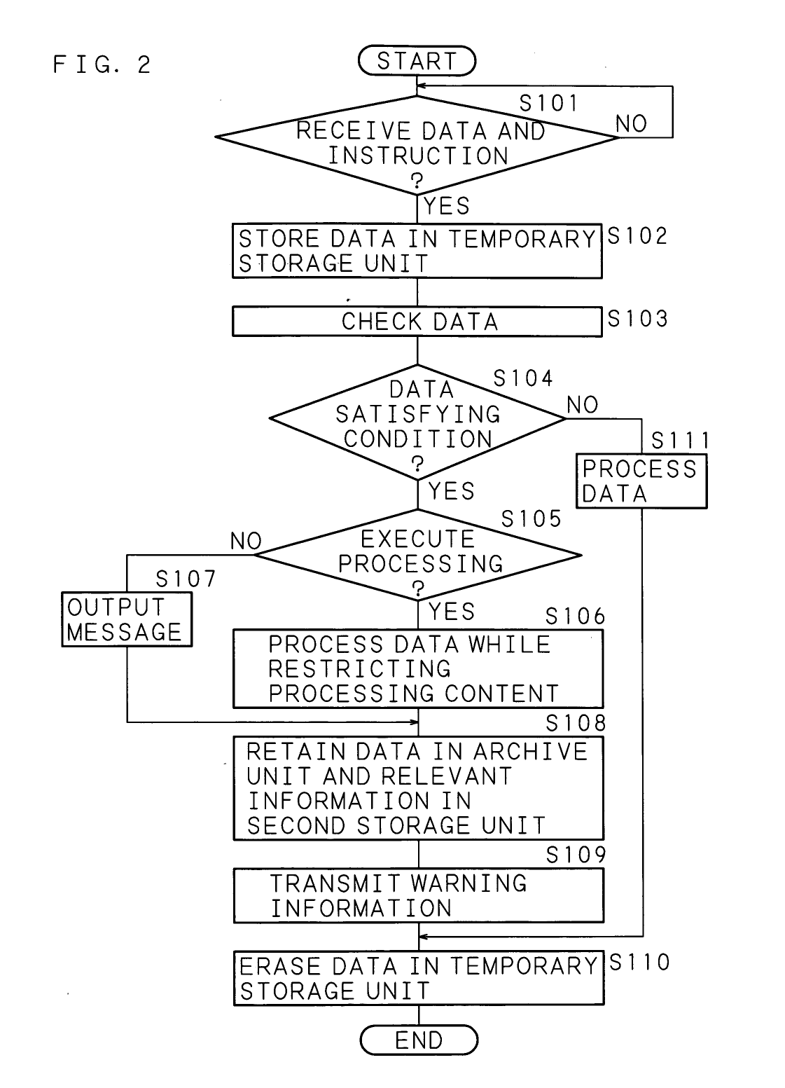

Next, the operations performed by the data processing apparatus 1 of the present invention will be explained using a flowchart. FIG. 2 is a flowchart showing the steps of processing performed by the data processing apparatus 1. The control unit 11 of the data processing apparatus 1 monitors reading of an image in the image reading unit 12, or monitors whether or not data to be processed has been received, for example, whether or not data has been received by the modem unit 151, communication unit 152 or interface unit 153, and monitors whether or not an instruction to process the data, such as an instruction to copy the image or an instruction to transmit a facsimile, has been received by the operating unit 13 (S101). If data to be processed and an instruction to process the data has not been received (S101: NO), the control unit 11 continues to monitor reception, and if data to be processed and an instruction to process the data has been received (S101: YES), the control unit 11 stores the received data in the temporary storage unit 191 (S102).

The judgment unit 14 reads the data stored in the temporary storage unit 191, checks the data by extracting the characteristics of the data and comparing them with predetermined characteristics stored therein (S103), and judges whether or not the received data is data satisfying a condition including the predetermined characteristics such as paper money or securities (S104). Note that the judgment unit 14 may perform the process of checking data before the control unit 11 stores the data in the temporary storage unit 191. If the received data is data satisfying a condition including the predetermined characteristics (S104: YES), the control unit 11 follows the control program stored in the ROM 17 and judges whether or not it has been set to execute processing according to the received processing instruction (S105).

If the control unit 11 has been set to execute processing (S105: YES), it follows the control program stored in the ROM 17 and performs processing of the data such as copying of the image by restricting the processing content, for example, outputting of the data by reducing the number of colors, and outputting of the data by decreasing the resolution, or outputting of a part of the data (S106). Next, according to the control program stored in the ROM 17, the control unit 11 stores the data judged to be data satisfying the predetermined condition in the archive unit 192, and further stores relevant information about the data, such as the received date, the content of the received processing instruction, and whether or not the processing has been executed, in the second storage unit 193 (S108). On the other hand, in step S105, if the control unit 11 has not been set to execute processing (S105: NO), it does not execute processing and outputs a message indicating that processing is not executable to the displaying means of the operating unit 13 (S107), and retains the data judged to be data satisfying the predetermined condition in the archive unit 192, and retains the relevant information about the data in the second storage unit 193 (S108).

Next, according to the control program stored in the ROM 17, the control unit 11 transmits warning information indicating that the data is retained in the archive unit 192 to the information processing apparatus 2 in the shop S from the communication unit 152 (S109). Thus, the shop staff is notified that there is data retained in the archive unit 192 without being erased. Next, according to the control program stored in the ROM 17, the control unit 11 erases the data stored in the temporary storage unit 191 (S110) and completes the processing. Alternatively, the control unit 11 may perform the process of moving the data stored in the temporary storage unit 191 to the archive unit 192 instead of erasing the data stored in the temporary storage unit 191 after storing the data in the archive unit 192.

In step S104, if the received data is not data satisfying a condition including the predetermined characteristics (S104: NO), the control unit 11 follows the control program stored in the ROM 17 and performs processing of the data according to the received processing instruction, such as copying of the image or transmission of a facsimile (S111), erases the data stored in the temporary storage unit 191 to invalidate the data (S110) and completes the processing. Alternatively, the control unit 11 may perform the process of invalidating the data by overwriting the data stored in the temporary storage unit 191 with other data, instead of invalidating the data by erasing it.

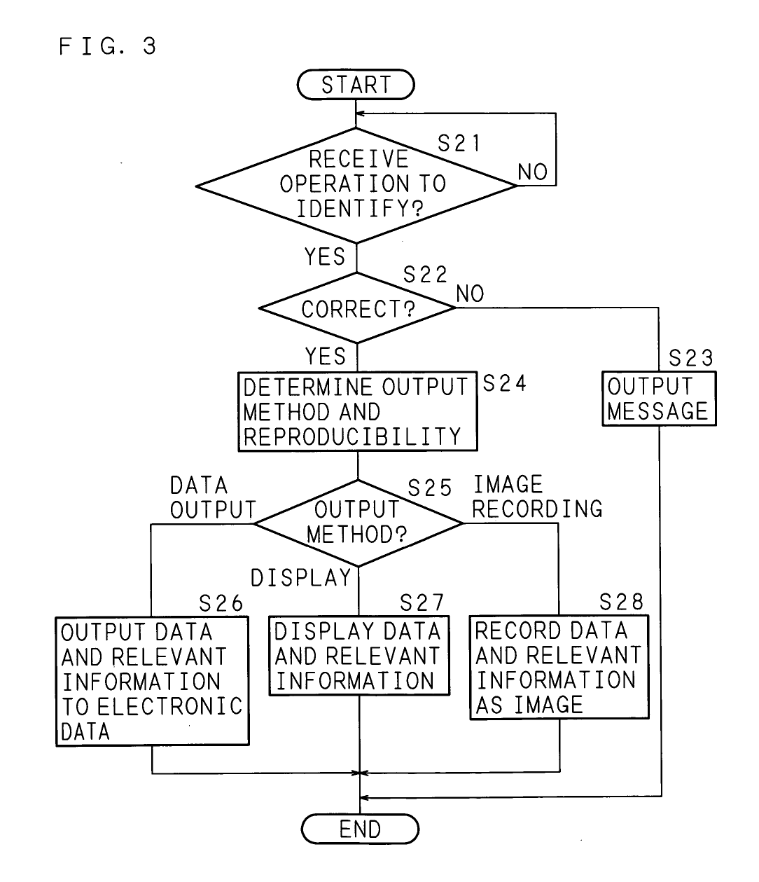

FIG. 3 is a flowchart showing the processing steps performed by the data processing apparatus 1 to output the data stored in the archive unit 192. The control unit 11 monitors whether or not a predetermined operation to identify the output authority to output the data has been received (S21), and, if the predetermined operation has not been received (S21: NO), the control unit 11 continues the monitoring action. In this case, the predetermined operation is an operation such as reception of key inputs in a predetermined order by the operating unit 13, or reception of a predetermined password, and a predetermined operation has been assigned to each of a plurality of types of output authority. A predetermined operation is performed by the shop staff in the shop S, or the manager of the data processing apparatus 1. When an operation to identify the output authority has been received (S21: YES), the control unit 11 follows the control program stored in the ROM 17 and judges whether or not the received operation is a predetermined correct operation (S22), and, if the received operation is not the correct operation (S22: NO), the control unit 11 outputs a message indicating that the data stored in the archive unit 192 cannot be outputted to the displaying means of the operating unit 13 (S23) and completes the processing.

If the received operation is the predetermined correct operation to identify the output authority to output the data (S22: YES), then the control unit 11 follows the control program stored in the ROM 17, identifies the output authority, and determines an output method for the data and reproducibility of the data to be outputted, according to the identified output authority (S24). At this time, as an output method, it is possible to determine a method in which the data is recorded as an image by the image forming unit 16, a method in which the data is displayed on the displaying means of the operating unit 13, or a method in which the data itself is outputted from the interface unit 153, etc. The reproducibility specifies the degree of reproducibility of the characteristics of data, such as the size, resolution and colors of data when outputting data, and the reproducibility of data is restricted by reducing the size, decreasing the resolution, reducing the number of colors, etc. when outputting the data.

Next, according to the control program stored in the ROM 17, the control unit 11 judges the determined output method (S25), and, if the data itself is to be outputted, the control unit 11 outputs the stored data and relevant information to an external recording medium or the like from the interface unit 153 (S26). This output method is used, for example, when the data is submitted as the evidence to a police in the event where copies of paper money were made. On the other hand, when the data is to be displayed, the control unit 11 follows the control program stored in the ROM 17, and displays the stored data and relevant information with the determined reproducibility on the displaying means of the operating unit 13 (S27). The output method in which the data is displayed is used when the shop staff in the shop S confirms the data after receiving warning information by the information processing apparatus 2. When the data is to be recorded as an image, the control unit 11 follows the control program stored in the ROM 17, and records the stored data and relevant information as an image on a record carrier such as recording paper by the image forming unit 16 (S28). Through the above-mentioned processing, the data processing apparatus 1 completes the processing.

As described in detail above, the data processing apparatus 1 of the present invention has the function of processing the received data while storing it and erasing the data for which the processing has been finished, and, if data satisfying a predetermined condition including predetermined characteristics such as paper money or securities has been received, the data processing apparatus 1 retains the received data without erasing it. Therefore, the data processing apparatus 1 of the present invention can retain the evidence of illegal operations when an illegal operation, such as copying of paper money, was performed. Moreover, by storing the relevant information about the data, such as the received date of the data or the content of processing, the data processing apparatus 1 can retain more detailed evidence of the illegal operation. Further, since the data processing apparatus 1 has the archive unit 192 for retaining data which was judged to be data satisfying a condition separately from the temporary storage unit 191 for storing data for processing purposes, a normal storage area for processing data is not influenced by the retained data, and the processing ability of the data processing apparatus 1 is maintained.

In addition, since the data processing apparatus 1 of the present invention gives notification that data which was judged to be data satisfying a predetermined condition has been stored in the archive unit 192, the shop staff in the shop S can take appropriate actions, such as reporting the fact to the management agency of the data processing apparatus 1. The data processing apparatus 1 of the present invention receives a predetermined operation, identifies the output authority to output data which was judged to be data satisfying the predetermined condition, and enables the output of the data. Therefore, a specified user such as the shop staff in the shop S can confirm the contents of the data stored in the archive unit 192. At this time, since it is possible to output the data by displaying the data on the displaying means of the operating unit 13 or recording the data as an image by the image forming unit 16, an output method for the data can be selected according to a purpose, such as just confirming the data by eyes, or storing the data by recoding it on paper. Moreover, the data processing apparatus 1 of the present invention can identify a plurality of types of output authority and specify an output method according to the type of the identified output authority, thereby allowing an operation according to the responsibility of a user. Besides, by restricting the reproducibility such as the size or colors when outputting the data, according to the type of output authority, it is possible to prevent the data from being retrieved and illegally used with the output authority that can be used by many users, such as ordinary shop staff in the shop S.

Moreover, since the data processing apparatus 1 of the present invention can also output relevant information related to data which was judged to be data satisfying the predetermined condition in association with the data, it is possible to confirm more detailed information for the data. Further, for the data judged to be data satisfying the predetermined condition, by restricting the content of data processing, for example, prohibiting output, reducing the number of colors, or decreasing the resolution, it is possible to prevent illegal use of the data such as copying of paper money.

Note that although this embodiment illustrates an example in which data satisfying a condition including predetermined characteristics which should be prohibited from being invalidated is paper money and securities, the present invention is not limited to this example. For example, the data may be data such as documents in which confidential information about a company using the data processing apparatus 1 is written. In this case, the documents which must be restricted for copying are characterized by stamping words such as “confidential” or “copy prohibited” on the documents, and the data processing apparatus 1 is set to restrict the output of data satisfying a condition including the characteristics such as “confidential” or “copy prohibited” and retain the data in the archive unit 192, and thus it is possible to prevent leakage of the company's confidential information and retain the evidence of illegal operations.

Besides, in this embodiment, although the data processing apparatus 1 of the present invention is a copying machine having the function of a facsimile machine and the function of inputting and outputting data, it may be an apparatus having only the function of a copying machine, or the function of a facsimile machine. Further, the data processing apparatus 1 of the present invention may be either a monochrome copying machine or a color copying machine. In addition, the data processing apparatus 1 of the present invention may be an image processing apparatus using a personal computer for performing image processing such as receiving image data and processing the image, or a server apparatus for retaining the received data.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A data processing apparatus comprising:
a storage unit for storing data; and
a control unit capable of performing operations of:
receiving data;
storing the received data;
processing the data stored in the storage unit;
invalidating the data stored in the storage unit;
judging whether or not the received data satisfies a predetermined condition; and
prohibiting an invalidation of the data if the data is judged to satisfy the predetermined condition.

2. The data processing apparatus according to claim 1, further comprising a second storage unit for storing information relevant to the data which was judged to satisfy the predetermined condition.

3. The data processing apparatus according to claim 1, wherein
the storage unit includes a temporary storage unit for temporarily storing the received data, and
an archive unit for retaining data which is prohibited from being invalidated.

4. The data processing apparatus according to claim 1, further comprising the control unit capable of performing an operation of:
giving notification that the invalidation of the data has been prohibited.

5. The data processing apparatus according to claim 1, further comprising the control unit capable of performing an operation of:
restricting the processing of the data, if the received data is judged to be predetermined specific data.

6. The data processing apparatus according to claim 1, further comprising the control unit capable of performing operations of:
receiving an operation of a user;
identifying output authority to output data which was judged to satisfy the predetermined condition, if a specific operation is received; and
outputting the data when the output authority was identified.

7. The data processing apparatus according to claim 6, further comprising the control unit capable of performing operations of:
displaying the data stored in the storage unit as an image; and
recording the data stored in the storage unit as an image on a record carrier.

8. The data processing apparatus according to claim 6, wherein
a plurality of types of output authority is identified, and an output method for the data is specified, according to the type of identified output authority.

9. The data processing apparatus according to claim 6, wherein
information relevant to data which was judged to be data satisfying the predetermined condition is outputted in association with the data.

10. The data processing apparatus according to claim 8, wherein
reproducibility of the data is restricted when outputting the data, according to the type of identified output authority.

11. A data processing apparatus comprising:
data receiving means for receiving data;
storing means for storing the data received by the data receiving means;
processing means for processing the data stored in the storing means;
invalidating means for invalidating the data stored in the storing means;
judging means for judging whether or not the data received by the data receiving means satisfies a predetermined condition; and
prohibiting means for prohibiting the invalidating means from invalidating the data if the judging means judges that the data satisfies the predetermined condition.

12. The data processing apparatus according to claim 11, further comprising second storing means for storing information relevant to data which was judged to satisfy the predetermined condition by the judging means.

13. The data processing apparatus according to claim 11, wherein
the storing means includes a temporary storage unit for temporarily storing the data received by the data receiving means, and
an archive unit for retaining data which is prohibited from being invalidated by the prohibiting means.

14. The data processing apparatus according to claim 11, further comprising notifying means for giving notification that the prohibiting means has prohibited the invalidation of the data.

15. The data processing apparatus according to claim 11, further comprising restricting means for restricting the processing of the data performed by the processing means, if the judging means judges that the data received by the data receiving means is predetermined specific data.

16. The data processing apparatus according to claim 11, further comprising:
operation receiving means for receiving an operation of a user;
identifying means for identifying output authority to output data which was judged to satisfy the predetermined condition by the judging means, if the operation receiving means receives a specific operation; and
outputting means for outputting the data when the identifying means identified the output authority.

17. The data processing apparatus according to claim 16, further comprising:
displaying means for displaying data as an image; and
recording means for recording data as an image on a record carrier,
wherein the outputting means outputs the data stored in the storing means to the displaying means or the recording means.

18. The data processing apparatus according to claim 16, wherein
the identifying means identifies a plurality of types of output authority, and the outputting means specifies an output method for the data, according to the type of output authority identified by the identifying means.

19. The data processing apparatus according to claim 16, wherein
the outputting means outputs information relevant to data which was judged to be data satisfying the predetermined condition by the judging means in association with the data.

20. The data processing apparatus according to claim 18, wherein
the outputting means restricts reproducibility of the data when outputting the data, according to the type of output authority identified by the identifying means.
